(19) United States
(12) Patent Application Publication
(10) Pub. No.: US 2023/0276276 A1
(43) Pub. Date: Aug. 31, 2023

(54) Method and System for Monitoring a Wireless Communication Network

(71) Applicant: Volkswagen Aktiengesellschaft, Wolfsburg (DE)

(72) Inventors: Frederik Kluwe, Grafhorst (DE); Matthias Dürrmann, Wolfsburg (DE)

(73) Assignee: Volkswagen Aktiengesellschaft, Wolfsburg (DE)

(21) Appl. No.: 18/005,881

(22) PCT Filed: Jul. 15, 2021
(86) PCT No.: PCT/EP2021/069698

§ 371 Date: Jan. 18, 2023

(30) Foreign Application Priority Data
Jul. 21, 2020 (DE) 10 2020 209 171.4

(51) Int. Cl. H04W 24/08; H04W 76/10

(52) U.S. Cl. CPC H04W 24/08; H04W 76/10

(57) ABSTRACT

The disclosure relates to monitoring a wireless communication network, wherein the wireless communication network comprises multiple access points under the same network name, and wherein mobile terminals can connect to the wireless communication network via the access points, wherein a wireless communication connection to the access points is established and checked in a targeted manner by means of a wireless network interface of at least one network monitoring device, based on a specified monitoring configuration with unique network identifiers stored therein and relating to access points to be checked, and wherein a check result for each of the checked access points is stored on a server via a wired communication connection formed by means of a wired network interface of the at least one network monitoring device.

### TECHNICAL FIELD

The invention relates to a method and a system for monitoring a wireless communication network.

### CROSS-REFERENCE TO RELATED APPLICATIONS

This application claims priority to German Patent Application No. DE 10 2020 209 171.4, filed on Jul. 21, 2020 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

In modern industrial production facilities, up to several thousand mobile terminals which are interconnected via wireless communication networks, in particular via Wi-Fi, are used. In this connection, it is often the case that, although a mobile terminal is connected to the wireless communication network, no connection can be established between the mobile terminal and a target system. Errors of this kind are difficult to analyze and can lead to problems in the production flow.

### SUMMARY

A need exists to improve a method and a system for monitoring a wireless communication network, in particular a wireless communication network used in industrial production.

The need is addressed by the subject matter of the independent claims. Some embodiments of the invention are apparent from the specification, the drawings, and the dependent claims.

### BRIEF DESCRIPTION OF THE DRAWINGS

FIG. 1 shows a schematic representation of a system for monitoring a wireless communication network

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for monitoring a wireless communication network is provided, wherein the wireless communication network comprises multiple access points under the same network name, and wherein mobile terminals can connect to the wireless communication network via the access points, wherein a wireless communication connection to the access points is established and checked in a targeted manner by means of at least one network monitoring device, by means of a wireless network interface of the at least one network monitoring device, based on a specified monitoring configuration with unique network identifiers stored therein and relating to access points of the wireless communication network to be checked, wherein a communication connection to at least one target system specified by means of the specified monitoring configuration is established and checked via the respectively established wireless communication connection, and wherein a check result for each of the checked access points is stored on a server via a wired communication connection formed by means of a wired network interface of the at least one network monitoring device.

Furthermore, a system for monitoring a wireless communication network is provided in some embodiments, wherein the wireless communication network comprises multiple access points under the same network name, and wherein mobile terminals can connect to the access points; comprising a server, which is configured to provide specified monitoring configurations and to receive and save check results; and at least one network monitoring device, wherein the at least one network monitoring device comprises: at least one wireless network interface, which is configured to connect to the access points of the wireless communication network, at least one wired network interface, which is configured to connect to the server, and a control apparatus, wherein the control apparatus is configured to establish and check a wireless communication connection to the access points in a targeted manner via the at least one wireless network interface based on a specified monitoring configuration with unique network identifiers stored therein and relating to access points of the wireless communication network to be checked, and to establish and check a communication connection to at least one target system specified via the specified monitoring configuration via the respectively established wireless communication connection, and to store a check result for each of the checked access points on the server via the at least one wired network interface.

The method and the system make it possible to monitor access points in a wireless communication network in a targeted manner and to log the monitoring. For this purpose, a wireless communication connection is established to each access point to be monitored and checked by means of at least one network monitoring device. This takes place in a targeted manner only for access points that are designated in a specified monitoring configuration. Identification of the access points takes place via a specified unique network identifier, such that the access points can be identified accurately and distinguished from other access points. This has the benefit that not all access points within range are checked, but rather only those that are defined in the specified monitoring configuration. In an industrial environment, in particular, this makes it possible, for example, to only monitor one wireless communication network configured for critical production. If a wireless communication connection can be successfully established to an access point, a communication connection to at least one target system specified by means of the specified monitoring configuration is then established, or rather formed, and checked via the established wireless communication connection. A target system of this kind in industrial production may be, for example, a process controller or a database server. A check result for each of the checked access points is stored on a server via a wired communication connection formed by means of a wired network interface of the at least one network monitoring device, in particular so as to link said check result to the unique network identifier and a time stamp. As a result, the check results can be logged in real time, such that an error search and optimization of the wireless communication network can be improved.

An access point is, in particular, a wireless access point to the wireless communication network. An access point comprises, for example, a router which can form a wireless communication connection to mobile terminals and connects same to a wired communication network, for example a local area network (LAN).

A wireless communication network may, in principle, be a wireless communication network of any design that is formed and provided by means of multiple access points. For example, a wireless communication network may be a wireless local area network (Wi-Fi) or a 5G network.

A mobile terminal is, for example, a personal computer or a laptop with a wireless communication interface, a mobile test station, a tablet computer, or a smartphone.

A check result may, in particular, comprise an item of information relating to whether a wireless communication connection to a checked access point and/or to a specified target system could or could not be successfully formed. Furthermore, a check result may, in particular, comprise quality parameters of a checked access point, for example a signal strength and/or signal quality, for example a signal-to-noise ratio or an error rate during transmission of data.

A network name may, in particular, be in the form of a service set identifier (SSID). The network name, in particular the SSID, is used by all access points of the wireless communication network together.

A specified monitoring configuration comprises at least one item of information or rather assignment of information about which access points should be monitored by a network monitoring device and how. In particular, the specified monitoring configuration comprises the associated unique network identifiers of the access points to be monitored or rather checked.

Parts of the network monitoring device, in particular the control apparatus, may be designed separately or collectively as a combination of hardware and software, for example as program code which is executed on a microcontroller or microprocessor. However, it is also possible for parts to be designed separately or collectively as an application-specific integrated circuit (ASIC).

In some embodiments, it is provided that the wireless communication network is designed as a Wi-Fi network, wherein the unique network identifier has a basic service set identification (BSSID). In particular, the Wi-Fi network is designed according to the standard IEEE 802.11. The BSSID may, for example, comprise a respective media access control (MAC) address of the individual access points in the wireless communication network. Each access point can be uniquely identified by means of the BSSID.

In some embodiments, it is provided that the specified monitoring configuration for the at least one network monitoring device is or has been stored on the server, wherein the at least one network monitoring device connects to the server and requests the respectively specified monitoring configuration prior to the check via the wired network interface. As a result, start-up of the method and system can be simplified. During start-up, a network monitoring device of the system then connects to the server and requests an associated specified monitoring configuration therefrom.

In some embodiments, it is provided that access points of the wireless communication network that are arranged in the environment within the range of the at least one network monitoring device are detected by means of the at least one network monitoring device, the unique network identifiers of which access points are ascertained and transmitted to the server by means of the wired communication connection in order to generate a monitoring configuration. This take place, in particular, during initial start-up. As a result, it can be determined and communicated to the server which access points are located within the range of the at least one network monitoring device. Proceeding from this, the server can create and provide the specified monitoring configuration in each case in a targeted manner and individually.

In some embodiments, it is provided that the wireless network interface and the wired network interface of the at least one network monitoring device are operated exclusively in an alternating manner. As a result, security during execution of the method and system can be increased, since at no point in time can a connection be formed between the wireless and wired network via the network monitoring device.

In some embodiments, it is provided that the check of the access points is repeated cyclically by means of the at least one network monitoring device. As a result, the wireless communication network can be monitored constantly, such that errors can be quickly detected and rectified.

In some embodiments, it is provided that an access point is restarted in a targeted manner if a check result for the access point includes that the access point is malfunctioning. As a result, quality can be increased during provision of the wireless communication network. For example, the server can compare the check results obtained from the at least one network monitoring device with specified threshold values, for example for one or more performance parameters (signal strength, signal-to-noise ratio, error rate, etc.) of the access points and prompt a restart of all access points at which at least one threshold value is exceeded or, alternatively, undershot. In the simplest case, however, the server only checks whether a wireless communication connection to the access point and subsequently to the at least one target system could or could not be successfully formed. If this could not be done successfully for an access point, this access point is restarted. The restart may take place both by means of a command transmitted via a wired network and using hardware, either manually or in a remote-controlled manner, for example in that an electrical power supply of the faulty access point is disconnected and reconnected in a remote-controlled manner.

Additional features for designing a corresponding system are apparent from the description of embodiments of the method. The benefits of the system in this context the same as for the embodiments of the method.

In some embodiments, a network monitoring device for the system is provided, comprising:
at least one wireless network interface, which is configured to connect to the access points of the wireless communication network,
at least one wired network interface, which is configured to connect to the server, and
a control apparatus, wherein the control apparatus is configured to establish and check a wireless communication connection to the access points in a targeted manner via the at least one wireless network interface based on a specified monitoring configuration with unique network identifiers stored therein and relating to access points to be checked, and to establish and check a communication connection to at least one target system specified via the specified monitoring configuration via the respectively established wireless communication connection, and to store a check result for each of the checked access points on the server via the wired network interface.

Furthermore, a server for a system of any one of the embodiments described is provided, which system is configured to provide specified monitoring configurations and to receive and save check results of the at least one network monitoring device.

Reference will now be made to the drawing in which the various elements of embodiments will be given numerical designations and in which further embodiments will be discussed.

Specific references to components, process steps, and other elements are not intended to be limiting.

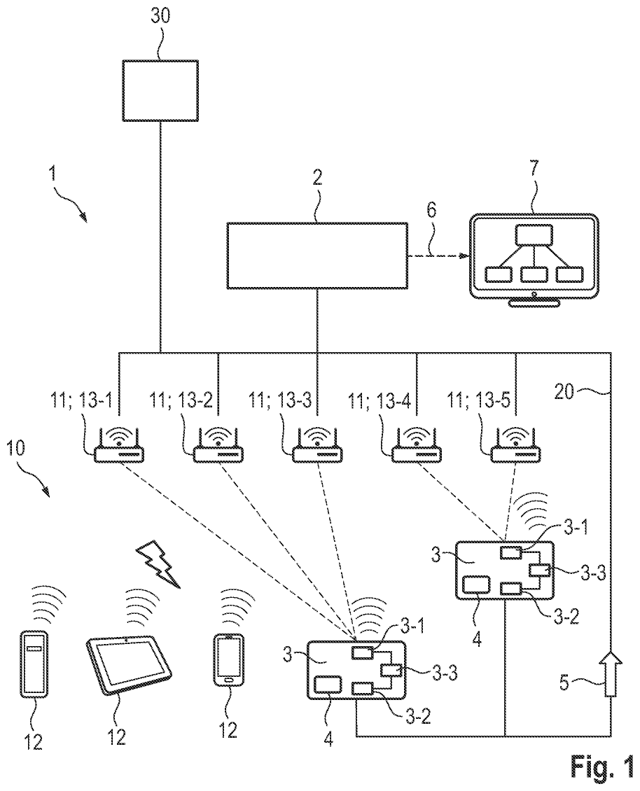

In FIG. 1, a schematic representation of an embodiment of the system 1 for monitoring a wireless communication network 10 is shown. The system 1 is configured to carry out the method described in this disclosure.

The wireless communication network 10 comprises multiple access points 11 under the same network name. Mobile terminals 12 can connect to the wireless communication network 10 via the access points 11. The wireless communication network 10 is, for example, a Wi-Fi network. The wireless communication network 10 is, in particular, an industrially used wireless communication network that provides, for example, a wireless communication infrastructure in a production or manufacturing plant.

The system 1 comprises a server 2 and, in the example shown, two network monitoring devices 3. The server 2 is configured to provide specified monitoring configurations 4 and to receive and save check results 5.

The network monitoring devices 3 each comprise one wireless network interface 3-1, one wired network interface 3-2, and one control apparatus 3-3. The wireless network interface 3-1 is configured to connect to the access points 11 of the wireless communication network 10. The wireless network interface 3-1 is designed as a WLAN interface in the example shown. In principle, however, another method or, alternatively, another standard may be used, for example the 5G standard. The wired network interface 3-2 is configured to connect to the server 2. This takes place via a wired communication connection 20 by means of a wired communication network, for example via a LAN or Ethernet.

The control apparatus 3-3 is designed, for example, as a microcontroller or microprocessor on which program code is executed in order to implement the individual measures of the method.

The control apparatus 3-3 is configured to establish and check a wireless communication connection to the access points 11 in a targeted manner via the wireless network interface 3-1 based on a specified monitoring configuration 4 with unique network identifiers 13-x stored therein and relating to access points 11 of the wireless communication network 10 to be checked.

Furthermore, the control apparatus 3-3 is configured to establish and check a communication connection to at least one target system 30 specified via the specified monitoring configuration 4 via the respectively established wireless communication connection. The target system 30 may, for example, be a process controller or database server with which the mobile terminals 12 must communicate during normal operation.

A check result 5 for each of the checked access points 11 is stored on the server 2 by means of the control apparatus 3-3 via the at least one wired network interface 3-2. In the simplest case, the check result 5 comprises an item of information relating to whether communication with the access points 11 respectively specified in the specified monitoring configuration 4 and the specified target system 30 is possible or not. Furthermore, further performance parameters can be checked or rather recorded and comprised in the check result 5.

The specified monitoring configuration 4 of the network monitoring device 3 shown on the left in FIG. 1 comprises the access points 11 with the unique network identifiers 13-1, 13-2, 13-3 in the example shown. The specified monitoring configuration 4 of the network monitoring device 3 shown on the right in FIG. 1 comprises the access points 11 with the unique network identifiers 13-4, 13-5 in the example shown. Furthermore, the specified monitoring configurations 4 comprise, in particular, requirements as to how often or rather at which time intervals the access points 11 are to be checked as well as specifications as to which variables and/or performance parameters of the access points 11 are to be checked (e.g. signal strength, signal quality, error rate, etc.).

The specified monitoring configurations 4 further comprise specifications relating to the at least one target system 30 to which a communication connection is to be established and checked.

The server 2 comprises, in particular, a data processing apparatus (not shown), which comprises a computing apparatus and a memory. The server 2 is used, in particular, to record the check results 5. Furthermore, the server 2 may be used to compare the check results 5, for example recorded performance parameters of the individual access points 11, with specified threshold values. It may be provided that the check results 5 stored in the server 2 are visualized in order, for example, to uncover weaknesses in the provision of the wireless communication network 10 and to expedite troubleshooting. For this purpose, the server 2 may generate accordingly prepared visualization data 6, for example on the basis of the stored check results 5 and a respective item of position information relating to the access points 11, and display said data on a display 7.

In particular, it is provided that the wireless communication network 10 is designed as a WLAN, wherein the unique network identifier 13-x has a basic service set identification (BSSID). The BSSID comprises, in particular, a MAC address of the individual access points 11.

It can be provided that the specified monitoring configurations 4 for the network monitoring devices 3 are or have been stored on the server 2, wherein the network monitoring devices 3 each connect to the server 2 via the wired network interfaces 3-2 and request the respectively associated specified monitoring configuration 4 from the server 2 prior to the check. In this connection, it is in particular provided that the respectively specified monitoring configurations 4 were created in the knowledge of the respective access points 11 located within the range of the individual network monitoring devices 3, i.e. the server 2 knows, for example, the positions of the network monitoring devices 3 and the positions of respective access points 11 located within range. For this purpose, a correspondingly designed map, for example, may be or have been stored in the server, which map is evaluated in order to generate the monitoring configurations.

It can be provided that access points 11 arranged in the environment within the respective range of the network monitoring devices 3 are detected by means of the network monitoring devices 3, the unique network identifiers 13-x of which access points are ascertained and transmitted to the server 2 by means of the wired communication connection 20 in order to generate the monitoring configurations 4. In particular, in this connection, all BSSIDs relating to one network name (e.g. SSID) can be ascertained and transmitted. In the example shown, the network monitoring device 3 shown on the left in FIG. 1 then transmits the unique network identifiers 13-1, 13-2, 13-3 to the server 2. In the example shown, the network monitoring device 3 shown on the right in FIG. 1 then transmits the unique network identifiers 13-4, 13-5 to the server 2. Based on the respectively transmitted unique network identifiers 13-x, the server 2 creates one specified monitoring configuration 4 in each case for the left-hand network monitoring device 3 and the right-hand network monitoring device 3. The respectively created monitoring configurations 4 comprise at least the unique network identifiers 13-x that were transmitted from the respective network monitoring devices 3 to the server 2. The access points 11 having the respectively specified unique network identifiers 13-x are checked based on the respectively specified monitoring configurations 4.

It can be provided that the wireless network interface 3-1 and the wired network interface 3-2 of the network monitoring devices 3 are exclusively operated in an alternating manner. As a result, security against attacks on the networks can be increased, since there is no connection or rather bridge between the wireless communication network 10 and the wired communication connection 20 at any time.

In particular, it is provided that the check of the access points 11 is repeated cyclically by means of the network monitoring devices 3. As a result, the access points 11 can be checked constantly and, in particular, regularly. A check sequence and the unique network identifiers 13-x are specified via the respectively specified monitoring configuration 4. The control apparatuses 3-3 of the network monitoring devices 3 then execute the measures cyclically, in particular at regular time intervals and/or in turns.

It can be provided that an access point 11 is restarted in a targeted manner if a check result 5 for the access point 11 includes that the access point 11 is malfunctioning. This may, in particular, be prompted by the server 2, wherein, for example, a restart signal generated by the server 2 is transmitted via the wired communication connection 20 to the access point 11 to be restarted.

The system 1 and the method described in some embodiments allow for improved monitoring of access points 11 in a wireless communication network 10. On account of the improved monitoring, an availability and a provided quality of the wireless communication network 10 can be improved locally as well as overall. The recording and storage of the check results 5 over the course of time allows for detailed evaluation of the performance parameters of the individual access points 11 and, as a result, makes it possible to detect weaknesses and to expedite troubleshooting in the event of errors. On account of the targeted check by means of the unique network identifiers 13-x, in particular by means of BSSIDs, it is possible to check only the specified access points 11 in a targeted manner, such that effort and costs can be reduced, and networks other than the wireless communication network 10 to be monitored are not considered or affected during the monitoring or rather check.

### LIST OF REFERENCE NUMERALS

1 System

2 Server

3 Network monitoring device

3-1 Wireless network interface

3-2 Wired network interface

3-3 Control apparatus

4 Specified monitoring configuration

5 Check result

6 Visualization data

7 Display

10 Wireless communication network

11 Access point

12 Mobile terminal

13-x Unique network identifier

20 Wired communication connection

30 Specified target system

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module, or other unit or device may fulfill the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A method for monitoring a wireless communication network, wherein the wireless communication network comprises multiple access points under the same network name, and wherein mobile terminals can connect to the wireless communication network via the access points, comprising:
establishing and checking a wireless communication connection to the access points in a targeted manner using at least one wireless network interface of a network monitoring device based on a predefined monitoring configuration with unique network identifiers stored therein and relating to access points of the wireless communication network to be checked; and
storing a check result for each of the checked access points on a server via a wired communication connection formed by a wired network interface of the at least one network monitoring device.

12. The method of claim 11, wherein the wireless communication network is configured as a Wi-Fi network, wherein the unique network identifier has a basic service set identification (BSSID).

13. The method of claim 11, wherein the specified monitoring configuration for the at least one network monitoring device is or has been stored on the server, the method comprising connecting, by the at least one network monitoring device, to the server and requesting the respectively specified monitoring configuration prior to the check via the wired network interface.

14. The method of claim 11, comprising:
detecting access points of the wireless communication network that are arranged in the environment within the range of the at least one network monitoring device by the at least one network monitoring device; and
determining and transmitting the unique network identifiers of which access points to the server by the wired communication connection in order to generate a monitoring configuration.

15. The method of claim 11, comprising operating the wireless network interface and the wired network interface of the at least one network monitoring device are exclusively in an alternating manner.

16. The method of claim 11, comprising cyclically repeating the check of the access points by the at least one network monitoring device.

17. The method of claim 11, comprising restarting one of the access points in a targeted manner if a check result for the access point indicates that the access point is malfunctioning.

18. A system for monitoring a wireless communication network, wherein the wireless communication network comprises multiple access points under the same network name, and wherein mobile terminals can connect to the access points, comprising:
a server, which is configured to provide specified monitoring configurations and to receive and save check results; and
at least one network monitoring device, wherein the at least one network monitoring device comprises:
at least one wireless network interface, which is configured to connect to the access points of the wireless communication network;
at least one wired network interface, which is configured to connect to the server; and
a controller;
wherein the controller is configured to establish and check a wireless communication connection to the access points in a targeted manner via the at least one wireless network interface based on a specified monitoring configuration with unique network identifiers stored therein and relating to access points of the wireless communication network to be checked, and to establish and check a communication connection to at least one target system specified via the specified monitoring configuration via the respectively established wireless communication connection, and to store a check result for each of the checked access points on the server via the wired network interface.

19. A network monitoring device, comprising:
at least one wireless network interface, which is configured to connect to the access points of the wireless communication network;
at least one wired network interface, which is configured to connect to the server; and
a controller;
wherein the controller is configured to establish and check a wireless communication connection to the access points in a targeted manner via the at least one wireless network interface based on a specified monitoring configuration with unique network identifiers stored therein and relating to access points to be checked, and to establish and check a communication connection to at least one target system specified via the specified monitoring configuration via the respectively established wireless communication connection, and to store a check result for each of the checked access points on the server via the wired network interface.

20. A server for the system of claim 18, which server is configured to provide specified monitoring configurations and to receive and save check results of the at least one network monitoring device.

21. The method of claim 12, wherein the specified monitoring configuration for the at least one network monitoring device is or has been stored on the server, comprising connecting, by the at least one network monitoring device, to the server and requesting the respectively specified monitoring configuration prior to the check via the wired network interface.

22. The method of claim 12, comprising
detecting access points of the wireless communication network that are arranged in the environment within the range of the at least one network monitoring device by the at least one network monitoring device, and
determining and transmitting the unique network identifiers of which access points to the server by the wired communication connection in order to generate a monitoring configuration.

23. The method of claim 13, comprising
detecting access points of the wireless communication network that are arranged in the environment within the range of the at least one network monitoring device by the at least one network monitoring device, and
determining and transmitting the unique network identifiers of which access points to the server by the wired communication connection in order to generate a monitoring configuration.

24. The method of claim 12, comprising operating the wireless network interface and the wired network interface of the at least one network monitoring device are exclusively in an alternating manner.

25. The method of claim 13, comprising operating the wireless network interface and the wired network interface of the at least one network monitoring device are exclusively in an alternating manner.

26. The method of claim 14, comprising operating the wireless network interface and the wired network interface of the at least one network monitoring device are exclusively in an alternating manner.

27. The method of claim 12, comprising cyclically repeating the check of the access points by the at least one network monitoring device.

28. The method of claim 13, comprising cyclically repeating the check of the access points by the at least one network monitoring device.

29. The method of claim 14, comprising cyclically repeating the check of the access points by the at least one network monitoring device.

30. The method of claim 15, comprising cyclically repeating the check of the access points by the at least one network monitoring device.
